(19) United States
(12) Patent Application Publication
(10) Pub. No.: US 2016/0328531 A1
(43) Pub. Date: Nov. 10, 2016

(54) Medical Data Transmitting System

(71) Applicant: Anthony P. DeCondo, JR., Elmwood Park, NJ (US)

(72) Inventor: Anthony P. DeCondo, JR., Elmwood Park, NJ (US)

(21) Appl. No.: 15/092,310

(22) Filed: Apr. 6, 2016

Related U.S. Application Data
(60) Provisional application No. 62/143,423, filed on Apr. 6, 2015.

(51) Int. Cl. G06F 19/00; H04L 12/58; G06Q 10/10; H04W 4/00

(52) U.S. Cl. CPC G06F 19/3418; H04W 4/008; H04L 51/38; G06Q 10/1097

(57) ABSTRACT

A medical data transmitting system is provided. The medical data transmitting system comprises a pacemaker and a mobile computer. An activatable computer program is programmed into the mobile computer. Upon activation of the computer program, the mobile computer wirelessly gathers and stores data received from the pacemaker in the mobile computer and electronically transmits the data to a predetermined location.

### CLAIM OF PRIORITY

This patent application claims priority under 35 USC 119 (e) (1) from U.S. Provisional Patent Application Ser. No. 62/143,423 filed Apr. 6, 2015, of common inventorship herewith entitled, “Pacemaker App,” which is incorporated herein by reference as though the same were set forth in its entirety.

### FIELD OF THE INVENTION

The present invention pertains to the field of medical equipment, and more specifically to the field of electronically transmitting medical data.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Approximately two hundred thirty five thousand heart patients are equipped with implantable, electronic pacemakers. These devices are generally used for the conditions of bradycardia and heart block. Bradycardia is a heartbeat that is too slow. Heart Block is when the electrical signals that move through the heart are disrupted or interrupted. A pacemaker consists of a battery, a computerized generator, and wires with electrodes or sensors at their tips. The battery powers the generator, and both are surrounded by a thin metal box. The wires connect the generator to a patient's heart. A pacemaker helps monitor and control the heartbeat. The electrodes detect the heart's electrical activity and send data through the wires to the computer in the generator. The pacemaker's computer also records the heart's electrical activity and heart rhythm. The pacemaker patient's cardiologist uses these recordings to adjust the pacemaker and monitor the condition of the patient's heart. Although the cardiologist uses a device that communicates wirelessly with the pacemaker, this process requires regular visits to the cardiologist.

The prior art has put forth several designs for electronically transmitting medical data. Among these are:

US Patent 2013/0132511 to Han-ku Lee, Hyo-Gun Yoon and Myoung-Jin Kim describes a system and method for processing medical information through a medical terminal. The system includes a mobile cloud system component and a service browser component. The service browser component is configured as an application in a user terminal to allow a user to use a medical information processing service, and induces access to the mobile cloud system component taking charge of medication information processing.

US Patent 2013/0066653 to Raymond Anthony Joao and Michael Nicholas Mantzouris describes an apparatus and a method for linking a pacemaker or a defibrillator to an electronic healthcare record. The said apparatus and a method for linking a pacemaker or a defibrillator to an electronic healthcare record or an electronic medical record of a patient can facilitate enhanced patient care and monitoring and enhanced pacemaker or defibrillator monitoring, control, servicing, and maintenance.

U.S. Pat. No. 8,630,660 to Sankar Ray and Farooq Bari describes a wireless telecommunications system which receives position information associated with a wireless mobile device of a user and a medical access point name from the wireless mobile device. The said system determines a gateway based on the position information and the access point name, receives medical information associated with the user from the wireless mobile device via the gateway, and then is able to provide, based on the medical information and the position information, the medical information to a computer system of a medical facility. The medical information includes drug allergies, food allergies, health issues, physician contact information, emergency contact information, and/or a preferred medical facility, among others. The medical information is useful in providing medical aid to the user of the wireless mobile device if the user is unable to communicate by verbal means, written means or sign means.

None of these prior art references describe the present invention.

### SUMMARY OF THE INVENTION

It is an object of the present invention to provide a software application for mobile computers, i.e., smartphones, tablets, and laptop computers that wirelessly gathers and stores data from an individual's heart pacemaker and electronically transmits this information to their cardiologist on a specified regular schedule.

The present invention is a medical data transmitting system. The medical data transmitting system comprises a pacemaker and a mobile computer. An activatable computer program is programmed into the mobile computer. Upon activation of the computer program, the mobile computer wirelessly gathers and stores data received from the pacemaker in the mobile computer and electronically transmits the data to a predetermined location.

In addition, the present invention includes a method for transmitting medical data. The method comprises providing a pacemaker, providing a mobile computer, programming the mobile computer with a computer program, activating the computer program, wirelessly gathering and storing data received from the pacemaker in the mobile computer, and electronically transmitting the data to a predetermined location.

The present invention further includes a medical data transmitting system. The medical data transmitting system comprises a pacemaker having a Bluetooth-enabled connection and a mobile computer having a Bluetooth-enabled connection and a screen. An icon is visible on the screen of the mobile computer. An activatable computer program is programmed into the mobile computer. Upon activation of the computer program, the mobile computer continuously and wirelessly gathers and stores data received from the pacemaker in the mobile computer and electronically transmits the data to a predetermined location on a predetermined regular schedule. Further, upon activation of the computer program, a series of concentric arcs on the icon emanate outwardly to symbolize radio waves of wireless communication signals.

### BRIEF DESCRIPTION OF THE DRAWINGS

FIG. 1 is a perspective view illustrating a medical data transmitting system, constructed in accordance with the present invention, with a mobile computer, i.e., smartphone, having an application icon consisting of an easily recognizable heart indicating which indicates the application in a resting mode with no wireless transmissions occurring.

FIG. 2 is a perspective view illustrating the medical data transmitting system, constructed in accordance with the present invention, with the application icon on the smartphone changed into a series of white concentric arcs, emanating outwardly, symbolizing radio waves of wireless communication signals thereby indicating transmissions are occurring.

FIG. 3 is a top plan view illustrating the medical data transmitting system, constructed in accordance with the present invention, with the application icon being an easily recognizable heart indicating the application currently is on the smartphone, but in a resting mode with no wireless transmissions occurring.

FIG. 4 is a top plan view illustrating the medical data transmitting system, constructed in accordance with the present invention, with the application icon on the smartphone changed into a series of white concentric arcs, emanating outwardly, symbolizing radio waves of wireless communication signals thereby indicating transmissions are occurring.

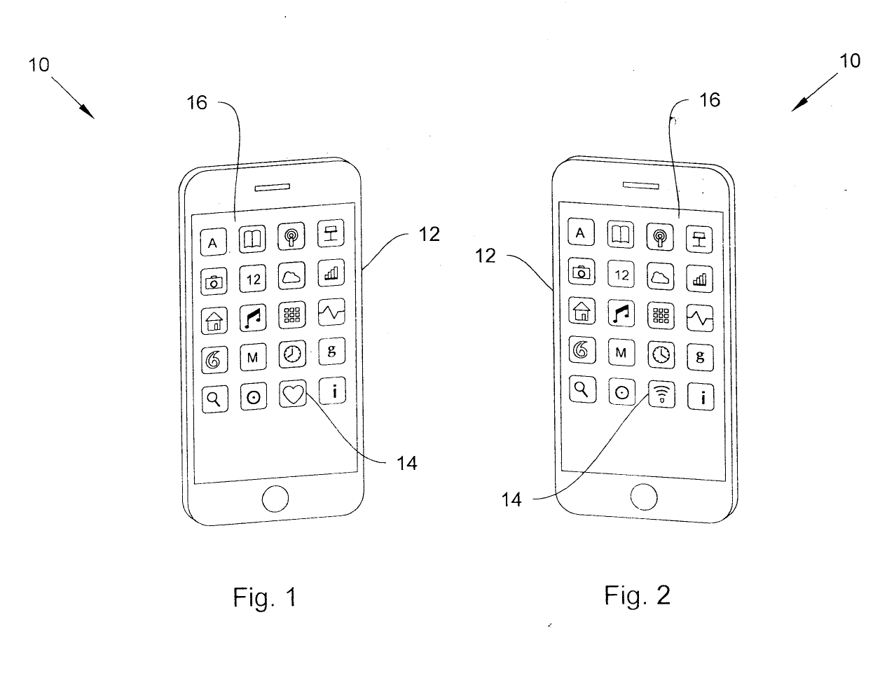

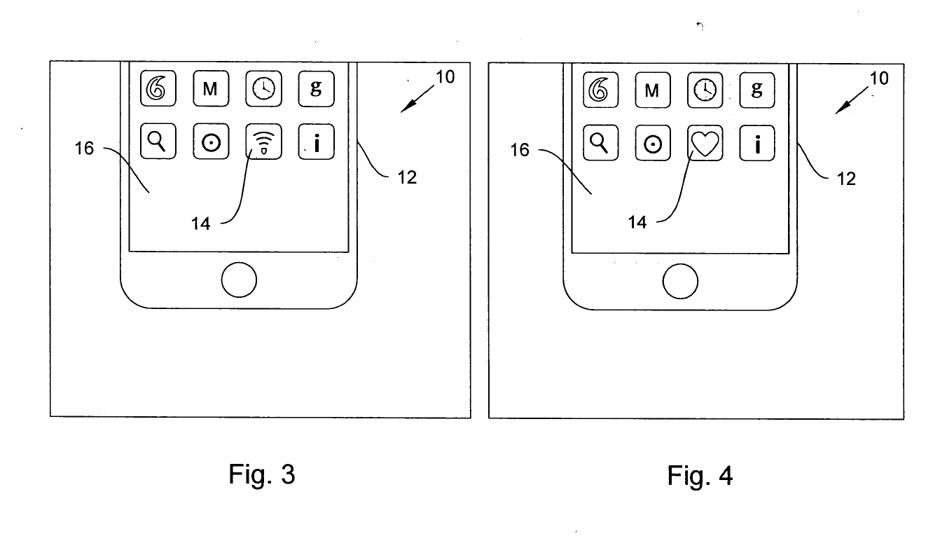

### DETAILED DESCRIPTION OF THE INVENTION

The present invention, hereinafter referred to as a Medical Data Transmitting System, indicated generally at 10, is a software application for mobile computers, i.e., smartphones, tablets, and laptop computers. Basically, mobile computers 12 allow transmission of data, voice, and video via the mobile computer 12 or any other wireless enabled device without having to be connected to a fixed physical link.

The software application of the Medical Data Transmitting System 10 of the present invention wirelessly gathers and stores data from an individual's heart pacemaker and transmits this information to their cardiologist on a specified regular schedule. The Medical Data Transmitting System 10 automatically records and transmits this vital medical data. Once installed, the Medical Data Transmitting System 10 functions automatically and continuously through a wireless connection to the pacemaker. In an embodiment of the present invention, the application setup process requests that the individual specify the days and times for transmission of the pacemaker data, and the email address or phone number of the medical information recipient. In this manner, the individual and information recipient can have all information transmitted on a desired schedule best suited for the individual's needs.

Once the application has been downloaded onto the mobile computer 12, the Medical Data Transmitting System 10 of the present invention presents an icon 14 visible on the screen 16 of the mobile computer 12. Preferably, the icon 14 is a stylized valentine heart, red with a black dot symbolizing the pacemaker although having a different icon 14 is within the scope of the present invention. When the application is running, preferably a series of concentric arcs on the icon 14 are emanating outwardly to symbolize radio waves of wireless communication signals. The Medical Data Transmitting System 10 is produced in software versions compatible with most popular mobile computer 12 operating systems such as Apple's iOS 7 operating system, for the iPhone and iPad, Google's mobile operating system for the Android, and Microsoft's mobile operating system for Windows smartphones, tablets, and computers. Preferably, the Medical Data Transmitting System 10 is available to users for a one time download fee, or a monthly or yearly subscription fee.

A notable distinction of the Medical Data Transmitting System 10 of the present invention is that it operates automatically and wirelessly, connecting a patient's pacemaker computer directly with their mobile computer 12, i.e., smartphone, tablet, laptop, or desktop computer, and in turn connecting this device to the patient's cardiologist or other desired information recipient. Using the Medical Data Transmitting System 10, a pacemaker patient needs fewer routine visits to their cardiologist, because the cardiologist now is receiving electronic transmissions of the patient's pacemaker data and has access to review the data without requiring a patient visit to the patient in the medical office. The Medical Data Transmitting System 10 is configured by the individual to transmit data on any schedule and at any time that the cardiologist specifies, providing convenience to the patient and flexibility to the cardiologist and his medical staff.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A medical data transmitting system comprising:
a pacemaker;
a mobile computer; and
an activatable computer program within the mobile computer;
wherein upon activation of the computer program, the mobile computer wirelessly gathers and stores data received from the pacemaker in the mobile computer and electronically transmits the data to a predetermined location.

2. The medical data transmitting system of claim 1 wherein the mobile computer is selected from the group consisting of smartphones, tablets, and laptop computers.

3. The medical data transmitting system of claim 1 wherein both the pacemaker and the mobile computer have Bluetooth-enabled wireless connections.

4. The medical data transmitting system of claim 3 wherein the pacemaker and mobile computer continuously communicate with each other through the Bluetooth-enabled wireless connection.

5. The medical data transmitting system of claim 1 wherein the data is transmitted from the mobile computer to the predetermined location on a predetermined regular schedule.

6. The medical data transmitting system of claim 1 wherein the data is transmitted from the mobile computer to the predetermined location on predetermined days at predetermined times.

7. The medical data transmitting system of claim 1 wherein the data is transmitted from the mobile computer to the predetermined location by email to a predetermined email address or by text to a predetermined phone number.

8. The medical data transmitting system of claim 1 and further comprising:
an icon visible on a screen of the mobile computer.

9. The medical data transmitting system of claim 8 wherein the icon is a stylized valentine heart, red with a black dot symbolizing the pacemaker.

10. The medical data transmitting system of claim 8 wherein upon activation of the computer program, a series of concentric arcs on the icon emanate outwardly to symbolize radio waves of wireless communication signals.

11. The medical data transmitting system of claim 1 wherein the computer program is produced in software versions compatible with Apple, Google, and Microsoft operating systems.

12. The medical data transmitting system of claim wherein the predetermined location is a cardiologist.

13. A method for transmitting medical data, the method comprising:
providing a pacemaker;
providing a mobile computer;
programming the mobile computer with a computer program;
activating the computer program;
wirelessly gathering and storing data received from the pacemaker in the mobile computer; and
electronically transmitting the data to a predetermined location.

14. The method of claim 13 wherein the pacemaker and the mobile computer have Bluetooth-enabled wireless connections, and further comprising:
continuously communicating between the pacemaker and mobile computer through the Bluetooth-enabled wireless connection.

15. The method of claim 13 and further comprising:
transmitting the data from the mobile computer to the predetermined location on a predetermined regular schedule.

16. The method of claim 13 and further comprising:
transmitting the data from the mobile computer to the predetermined location on predetermined days at predetermined times.

17. The method of claim 13 and further comprising:
providing ah icon visible on a screen of the mobile computer.

18. The method of claim 17 wherein the icon is a stylized valentine heart, red with a black dot symbolizing the pacemaker.

19. The method of claim 17 and further comprising:
emanating a series of concentric arcs on the icon outwardly to symbolize radio waves of wireless communication signals upon activation of the computer program.

20. A medical data transmitting system comprising:
a pacemaker having a Bluetooth-enabled connection;
a mobile computer having a Bluetooth-enabled connection and a screen;
an icon visible on the screen of the mobile computer; and
an activatable computer program within the mobile computer;
wherein upon activation of the computer program, the mobile computer continuously and wirelessly gathers and stores data received from the pacemaker in the mobile computer and electronically transmits the data to a predetermined location on a predetermined regular schedule; and
wherein upon activation of the computer program, a series of concentric arcs on the icon emanate outwardly to symbolize radio waves of wireless communication signals.
